(19) United States
(12) Patent Application Publication
(10) Pub. No.: US 2013/0022270 A1
(43) Pub. Date: Jan. 24, 2013

(54) Optical Character Recognition of Text In An Image for Use By Software

(71) Applicant: Todd Kahle, Hartford, WI (US)

(72) Inventor: Todd Kahle, Hartford, WI (US)

(21) Appl. No.: 13/188,873

(22) Filed: Jul. 22, 2011

(51) Int. Cl. G06K 9/18; G06K 9/20

(52) U.S. Cl. 382/182; 382/321

(57) ABSTRACT

A computer implemented method and apparatus that can OCR an image, or selected portions of an image, and then provide options to a user for use of the results of the OCR, including passing the results of the OCR to a software program so the software program can perform some action on the results of the OCR.

### FIELD OF THE INVENTION

The present invention relates generally to optical character recognition (OCR) of text in an image, and more particularly to OCR of text, such that the OCR result may be used to perform some action.

### BACKGROUND OF THE INVENTION

OCR has been known for years, and involves the electronic translation of scanned images into a machine-encoded text. The images can be of handwritten materials, typewritten or printed text, for example. OCR is mainly used to convert books and documents into electronic files, or to computerize record-keeping documents, for example. OCR makes it possible to edit the text, search for a word or phrase in the OCR'ed document, and to store the OCR'ed document for later manipulation.

Images come in many forms, and many images contain unrecognized text. For example, an electronic image that could contain unrecognized text would be a pdf image generated by a flat bed document scanner. Another popular form of image storage is the microform. Microform images have also been used for many years in archiving a variety of documents or records by photographically reducing and recording the document in a film format. Examples of typical microform image formats include microfilm/microfiche, aperture cards, jackets, 16 mm or 35 mm film roll film, cartridge film and other micro opaques. For example a microfiche article is a known form of graphic data presentation wherein a number of pages or images are photographically reproduced on a single “card” of microfiche film (such as a card of 3×5 inches to 4×6 inches, for example). Any suitable number of pages (up to a thousand or so) may be photographically formed in an orthogonal array on a single microfiche card of photographic film. The microfiche film may then be placed in an optical reader and moved over a rectilinear path until an image or a selected page is in an optical projection path leading to a display screen. Although other electronic, magnetic or optical imaging and storage techniques and media are available, there exists an extensive legacy of film type records storing the likes of newspapers and other print media, business records, government records, genealogical records, and the like.

With the ever increasing popularity of the Internet, and its ability to be searched for a practically unimaginable variety of topics and data, a number of web browsers and search engines have been developed. Web browsers such as Internet Explorer and Mozilla Firefox, for example, provide users with an interface to the Internet for interaction with the vast amount of information resources on the Internet. Once a user has access to the Internet through a web browser, a search engines allow a user to enter search information, such as a word or a phrase, and then the search engine scans the Internet for information that matches or is somehow related to the search information. The results of the search are typically provided in the form of an extensive listing of accessible information. Examples of search engines include GOOGLE, BING and YAHOO, just to name a few. Other Internet related software where information is entered and results are provided to the user includes dictionaries, encyclopedias, yellow pages, people searches, job searches, maps, new and real estate, again, just to name a few.

What is needed in the art is a method and apparatus that can OCR an image or selected portions of an image, and then provide options to a user for passing the results of the OCR to software so the software can perform some action on the results of the OCR.

### SUMMARY OF THE INVENTION

The present invention provides, in one form thereof, a method for providing optical character recognition results for use to perform some action. The method comprises the steps of: providing an image on a monitor; receiving an indication of at least one region on the monitor for optical character recognition (OCR); initiating OCR of the indicated at least one region for producing OCR results; and using the OCR results to perform some action.

Advantages of embodiments of the present invention are that it provides a method and apparatus that can OCR an image, or selected portions of an image, and then provide options to a user for passing the results of the OCR to software so the software can perform some action on the results of the OCR. For example, the method and apparatus can pass the results of the OCR to an Internet search engine and initiate the search, with the search engine providing the results of the search.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an embodiment of a digital microform imaging system according to the present invention;

FIG. 2A is an fragmentary, exploded perspective view of the digital microform imaging apparatus used with the system of FIG. 1;

FIG. 2B is an exploded, fragmentary, perspective view of the digital microform imaging apparatus of FIG. 2A, illustrating particularly the X-Y table mobility;

FIG. 3 is a top view of the digital microform imaging apparatus of FIG. 2A;

FIG. 4 is a schematic view of the digital microform imaging system of FIG. 1;

FIG. 5 is a screen shot of an embodiment of a computer user interface of the digital microform imaging system of FIG. 1, including image data;

FIG. 6 is a screen shot of similar to FIG. 5, but also including a setup dialog box;

FIG. 7 is a screen shot of similar to FIG. 5, but also including a digital magnifier window;

FIG. 8 is a flow chart of an embodiment of a method according to the present invention;

FIG. 9 is a screen shot of an embodiment of a computer user interface according to the method of FIG. 8;

FIG. 10 is a flow chart of an example of the method of FIG. 8;

FIG. 11 is a schematic view of a general computing environment including the digital microform imaging system and computer of FIG. 1;

FIG. 12 is a perspective view of another embodiment of a digital microform imaging apparatus according to the present invention, particularly illustrating a motorized roll film microform media support; and

FIG. 13 is a perspective view of another embodiment of a digital microform imaging apparatus according to the present invention, particularly illustrating a hand operated roll film microform media support.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE PREFERRED EMBODIMENT

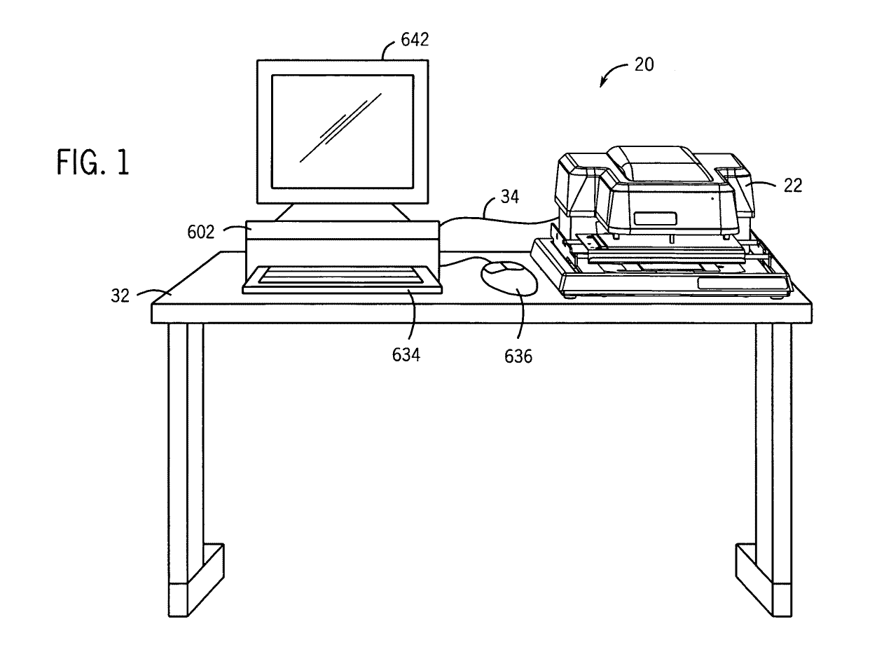

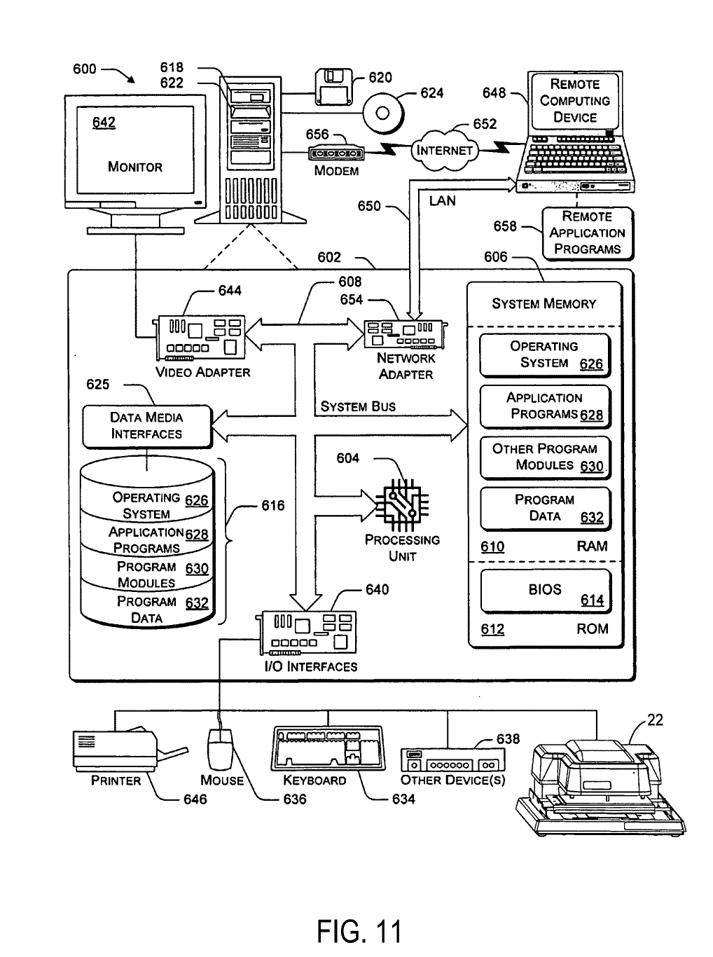

Referring now to the drawings, and more particularly to FIG. 1, there is shown a digital microform imaging system 20 which generally includes digital microform imaging apparatus (DMIA) 22 connected to a computer 602. Computer 602 can include one or more displays 642, and user input devices such as a keyboard 634 and mouse 636. DMIA 22 and computer 602 can be placed on a worksurface 32 of a desk, or other worksurfaces, for convenient access and ease of use. DMIA 22 can be electrically connected to computer 602 via cable 34, which may provide communication using a FireWire IEEE 1394 standard, for example. Although cable 34 is described as an electrical type cable, alternatively DMIA 22 and computer 602 can communicate via fiber optics, or wirelessly through infrared or radio frequencies, for example. Other details of computer 602 and the general computing environment are discussed in more detail below and shown in FIG. 11. DMIA 22 is described in U.S. patent application Ser. No. 11/748,692, titled “DIGITAL MICROFORM IMAGING APPARATUS”, filed May 15, 2007, which application is incorporated by reference as if fully setforth herein.

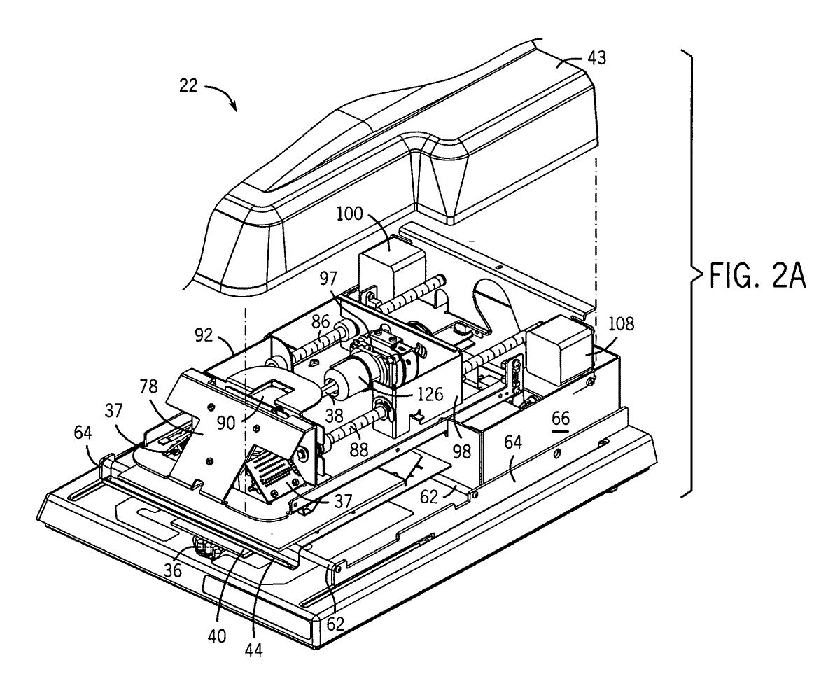

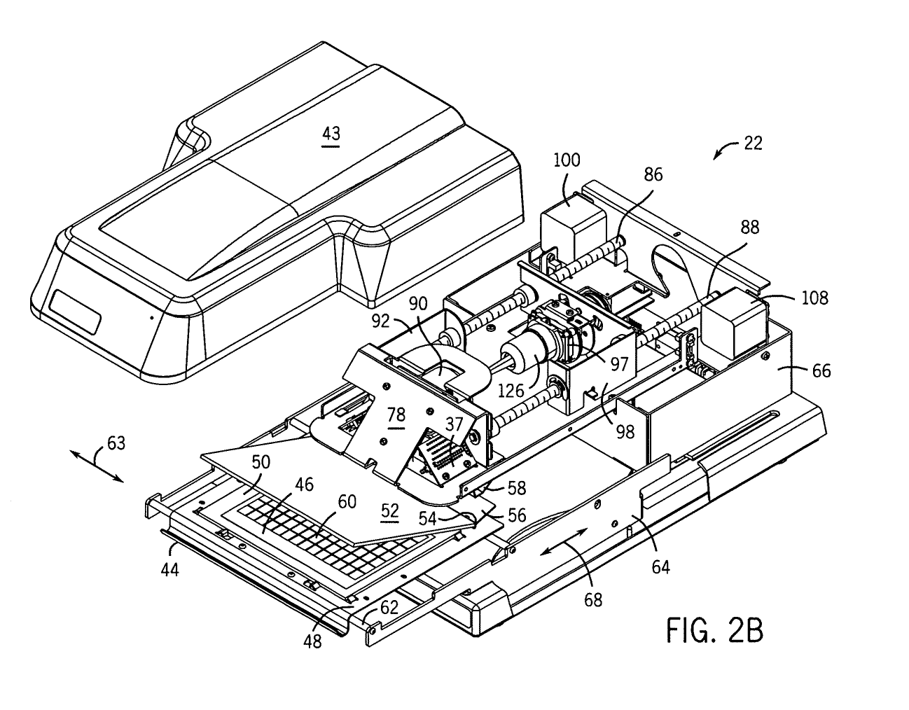

Referring more particularly to FIGS. 2A-4, DMIA 22 includes an approximately monochromatic illumination source 36, such as a light emitting diode (LED) array or other monochromatic illumination source, transmitting an incident light 38 through a diffuse window 40 along a first optical axis 42 of apparatus 22. Light emitting diode (LED) array 36 can be an approximately 13×9 array of individual LEDs operating in the 495-505 nm wavelength region, although array 36 is not limited to such parameters. The relatively monochromatic nature of source 36 helps reduce chromatic aberration in DMIA 22, thereby improving the optical resolution of the images produced. Diffuse window 40 can be a frosted glass which diffuses the light emanating from array 36, thereby creating a more uniform illumination source. DMIA 22 can include cover 43 to help protect the inner elements of DMIA 22.

A microform media support 44 is configured to support a microform media 46 after diffuse window 40 and along first optical axis 42. In the embodiment shown support 44 is an X-Y table, that is, support 44 is movable in a plane which is approximately orthogonal to first optical axis 42. Referring particularly to FIGS. 2A and 2B, microform media support 44 includes frame 48 which supports first window 50 on one side of microform media 46, and second window 52 on the other side of microform media 46. Second window 52 hinges upward at 54 when frame 48 is moved forward to the extent that lever 56 (connected to second window 52) contacts ramps 58 (one ramp on either side), and similarly, hinges downward at 54 when frame 48 is moved rearward as lever 56 is released from contact with ramp 58. In this way the microform media 46, shown as a microfiche film with an array of images or microform segments 60, can be placed and held securely between windows 50, 52 for viewing. Frame 48, along with windows 50, 52 and media 46, are slidingly supported on rods 62 by bearings (not shown) to allow a transverse movement 63 of frame 48, windows 50, 52 and media 46. Rods 62 are connected to brackets 64, which brackets are slidingly supported by chassis 66 and bearings (not shown) to allow a longitudinal movement 68 of frame 48, windows 50, 52, media 46 and rods 62.

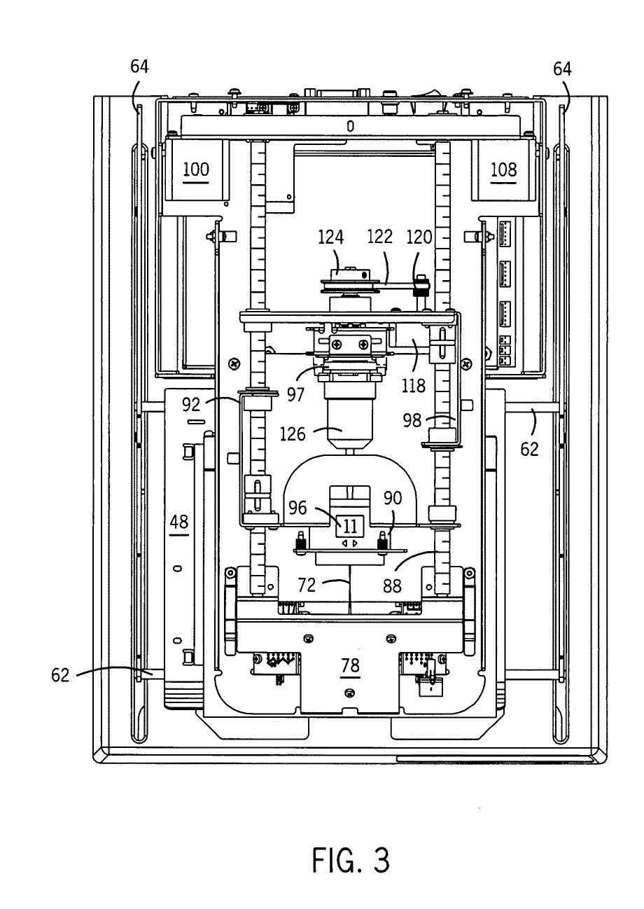

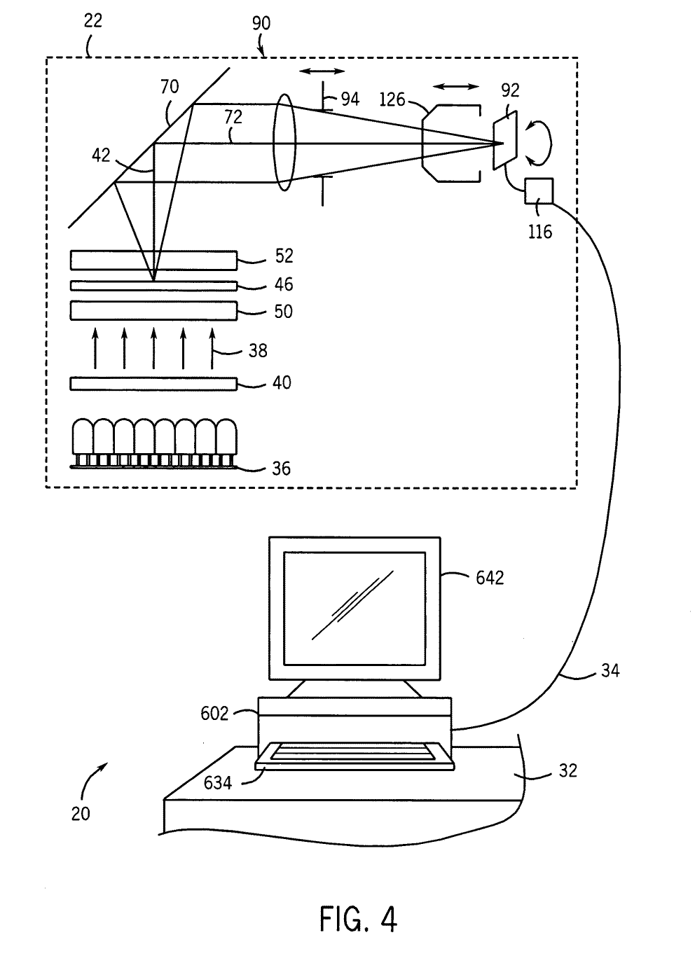

An approximately 45° fold mirror 70 (FIGS. 3 and 4) reflects the incident light transmitted through microform media 46 approximately 90° along a second optical axis 72. First optical axis 42 and second optical axis 72 can be thought of as segments of the single or main optical axis. Mirror 70 is connected by a three point mount to mirror mount 78 by fasteners and springs. Mirror mount 78 is connected to chassis 66 as shown. Fold mirror 70 advantageously shortens the overall longitudinal length of the optical axis which allows DMIA 22 to be more compact.

An imaging subsystem 84 includes a first lead screw 86 and a second lead screw 88 where each lead screw is approximately parallel with second optical axis 72. A lens 90 is connected to a first carriage 92 which is linearly adjustable by rotating first lead screw 86. Lens 90 includes stop 94 and f-stop adjustment 96 which can adjust the aperture of stop 94. Lens 90 can have a fixed focal length of 50 mm, for example. This focal length has the advantage of a relatively large depth of focus. A rough formula used to quickly calculate depth of focus is the product of the focal length times the f-stop divided by 1000, which yields a depth of focus of 0.55 mm for a 50 mm focal length and f11 f-stop adjustment. An area sensor 97 is connected to a second carriage 98 which carriage is linearly adjustable by rotating second lead screw 88. Area sensor 97 can be an area array CCD sensor with a two dimensional array of sensor elements or pixels, for example, with a 3.5 μm² pixel size, or other types of sensors and pixel sizes depending on resolution size requirements. The area array nature of sensor 97, when compared to a line sensor, eliminates the need for scanning of the sensor when viewing two dimensional images. The overall novel optical layout of the present invention including the separately adjustable area sensor 97 and lens 90; 45° fold mirror 70; and film table 44 location; algorithms for moving the lens and sensor to appropriate respective locations to achieve proper magnification and focus of the image; and the lens focal length and relatively large depth of focus, allows DMIA 22 to autofocus without the need for iterative measurements and refocusing the of lens 90 during magnification changes to accommodate different reduction ratios of different film media. Further, the present invention can easily accommodate reduction ratios in the range of 7× to 54×, although the present invention is not limited to such a range.

A first motor 100 is rotationally coupled to first lead screw 86 by a timing pulley, a belt with teeth, and another timing pulley, similar to timing pulley 120, belt 122 with teeth, and timing pulley 124, respectively, and a second motor 108 is rotationally coupled to second lead screw 88 by a timing pulley, a belt with teeth, and another timing pulley, also similar to timing pulley 120, belt 122 with teeth, and timing pulley 124, respectively. A controller 116 is electrically connected to first motor 100, second motor 108 and area sensor 97, where controller 116 is for receiving commands and other inputs from computer 24 or other input devices, controlling first motor 100 and second motor 108, and other elements of DMIA 22, and for outputting an image data of area sensor 97. Consequently, controller 116 can include one or more circuit boards which have a microprocessor, field programmable gate array, application specific integrated circuit or other programmable devices; motor controls; a receiver; a transmitter; connectors; wire interconnections including ribbon wire and wiring harnesses; a power supply; and other electrical components. Controller 116 also provides electrical energy and lighting controls for LED array 36.

A third motor 118 is rotationally coupled to area sensor 97, where controller 116 additionally controls third motor 118 through electrical connections as with motors 100 and 108. For example, controller 116 can rotate area sensor 97, using motor 118, timing pulley 120, belt 122 with teeth, and timing pulley 124, to match an aspect ratio of microform media 46, and particularly an aspect ratio of images 60. A light baffle 126 can be connected to area sensor 97 to reduce stray light incident on sensor 97 and thereby further improve the resolution and signal to noise of DMIA 22. Light baffle 126 can have an antireflective coating at the front and inside surfaces of the baffle to further reduce stray light incident on sensor 97. Motors 100, 108 and 118 can be DC servomotors, or other motors.

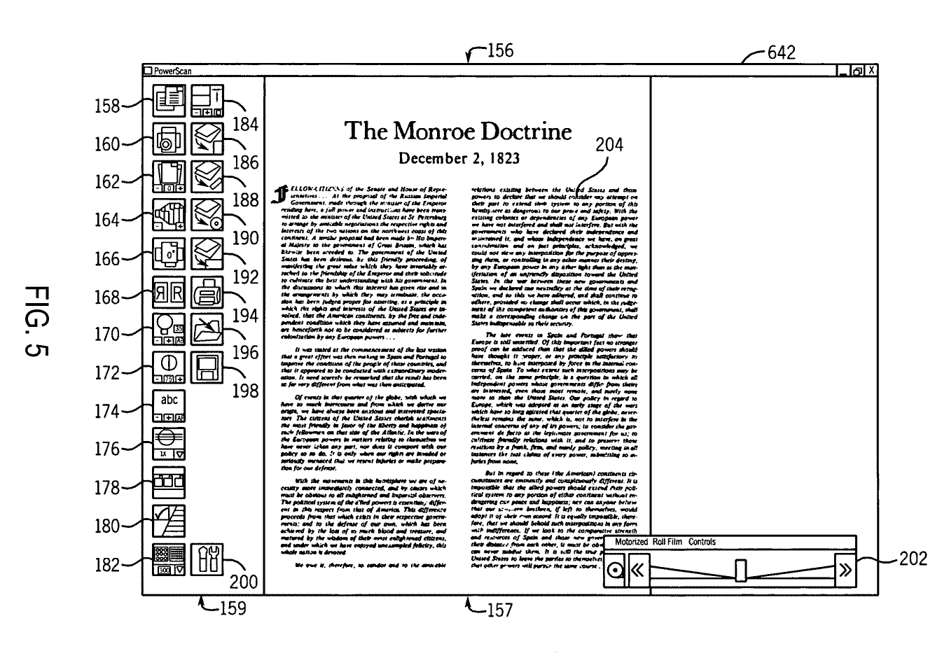

Referring to FIG. 5, computer 602 includes a software computer user interface (CUI) 156 displayed by monitor 642 with user inputs to control DMIA 22 in general, and particularly, illumination system 36, motors 100, 108 and 118, and other elements of DMIA 22. CUI 156 can be in the form of at least one instruction executed by the at least one processor 604, where the instructions of CUI 156 are stored on computer-readable storage medium such as any number of program modules stored on hard disk 616, magnetic disk 620, optical disk 624, ROM 612, and/or RAM 610, or other computer-readable storage medium. CUI 156 generally includes a display area 157 and a toolbar 159 with user selectable controls as follows. Toolbar 159 can include the following software user input buttons: positive/negative film type 158; landscape/portrait film orientation 160; rotate optical 162 for rotating third motor 118; optical zoom 164 which controls first motor 100 and second motor 108; digital image rotation 166; mirror image 168 for adjusting for when media 46 is placed on support 44 upside down; brightness 170 which adjusts the speed of sensor 97; contrast 172; focus 174 with manual focus (−/+) and autofocus (AF), also controlling first motor 100; digital magnifier 176; live button 178; scan type/selecting grayscale, grayscale enhanced, halftone 180; resolution/image capture 182; scan size button for prints/fit to page 184; save image scan to computer drive #1 186; save image scan to computer drive #2 188; save image scan to computer drive #3 190; save image scan to email 192; print image 194; restore settings 196; save settings 198; setup/tools 200; and motorized roll film controls 202 for embodiments with motorized roll film attachments. These controls of toolbar 159 can be selected by a user with a left click of mouse 636. Other toolbar input selections are contemplated.

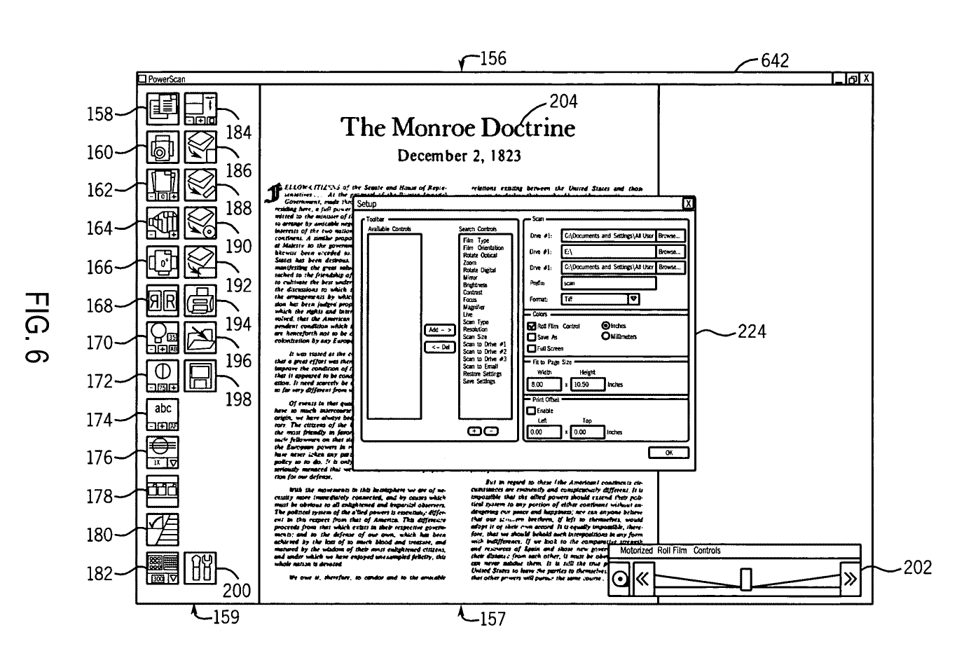

FIG. 6 illustrates the configurable nature of CUI 156, and more particularly toolbar 159. Selecting setup/tools 200 opens dialog box 224. Toolbar controls, and other parameters are added, deleted and/or changed as shown by dialog box 224.

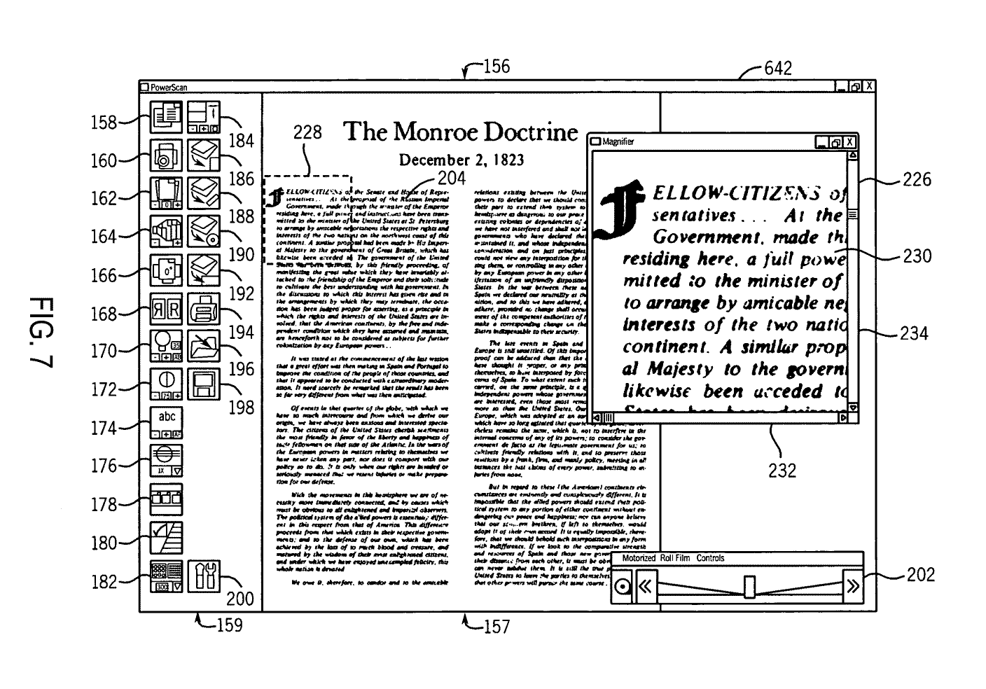

FIG. 7 illustrates a particularly advantageous aspect of CUI 156. By selecting the optical zoom 164, a user can select the magnification of image data 204 derived from microform segment 60. However, it is generally advantageous to select this optical magnification such that image data 204 includes all of the data of a particular microform segment 60, so that a user knows, at least in general, what elements or data are on this segment, and for subsequent printing, storing or emailing of the segment 60. However, depending on the size of monitor 642, the quality of the originally scanned record, the reproduction quality of microform media 46 and segment 60, and the resolution capabilities of DMIA 22, image data 204 may not be readable, or easily readable, by a typical user.

By selecting the magnifier glass portion of digital magnifier 176, CUI 156 creates magnifier window 226. An indicator box 228 identifies which subsegment 230 of image data 204 is being illustrated in magnifier window 226. By clicking on indicator box 228 and dragging it around image data 204 a user can pan around image data 204, with the subsegment data of new locations being shown in magnifier window 226. However, the data within indicator box 228 itself is not magnified, and indicator box 228 itself does not provide the functionality to expand indicator box 228. Instead, selecting the arrow portion of digital magnifier 176 selects the digital magnification of the subsegment 230 of image data 204 within magnifier window 226, and magnifier window 226 can be expanded transversely, longitudinally and diagonally by placing the cursor on one of the sides, or a corner, and mouse clicking and dragging to expand magnifier window 226, as is typical in windows of Windows® operating system. Scroll bars 232, 234 of magnifier window 226 can be used to scroll within window 226. Although indicator box 228 moves and expands with magnifier window 226, the data within indicator box 228 is not digitally magnified, in contrast with the data within magnifier window 226.

A programmer with ordinary skill in the art in Windows® operating system including callable subroutines, or other operating systems and their callable subroutines, and C++ or Visual Basic programming language can create the CUI 156 as shown in FIGS. 5-7 and defined above.

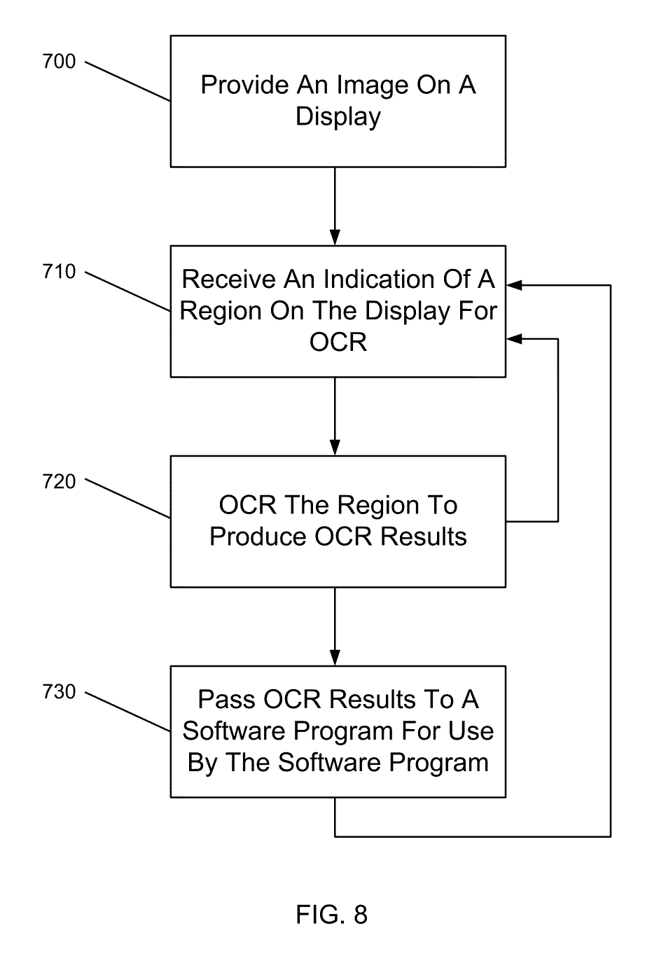

When a user is viewing the digital image, the user may be interested in learning more about a particular word or topic that is displayed in the digital image, but is not readily copyable because the image is not in an editable form, e.g., the image contains electrically unrecognizable text. The method illustrated in FIG. 8 allows the user to select one or more regions on the display that can be OCR'ed. The user can then select a software program, for example a local software program such as a dictionary or encyclopedia, or a web based search engine such as GOOGLE, and by clicking on the desired local or remote software program, the method passes the results of the OCR to the selected software program. At this point, the software program will open, and the OCR results are passed to that software program and the desired action will be executed.

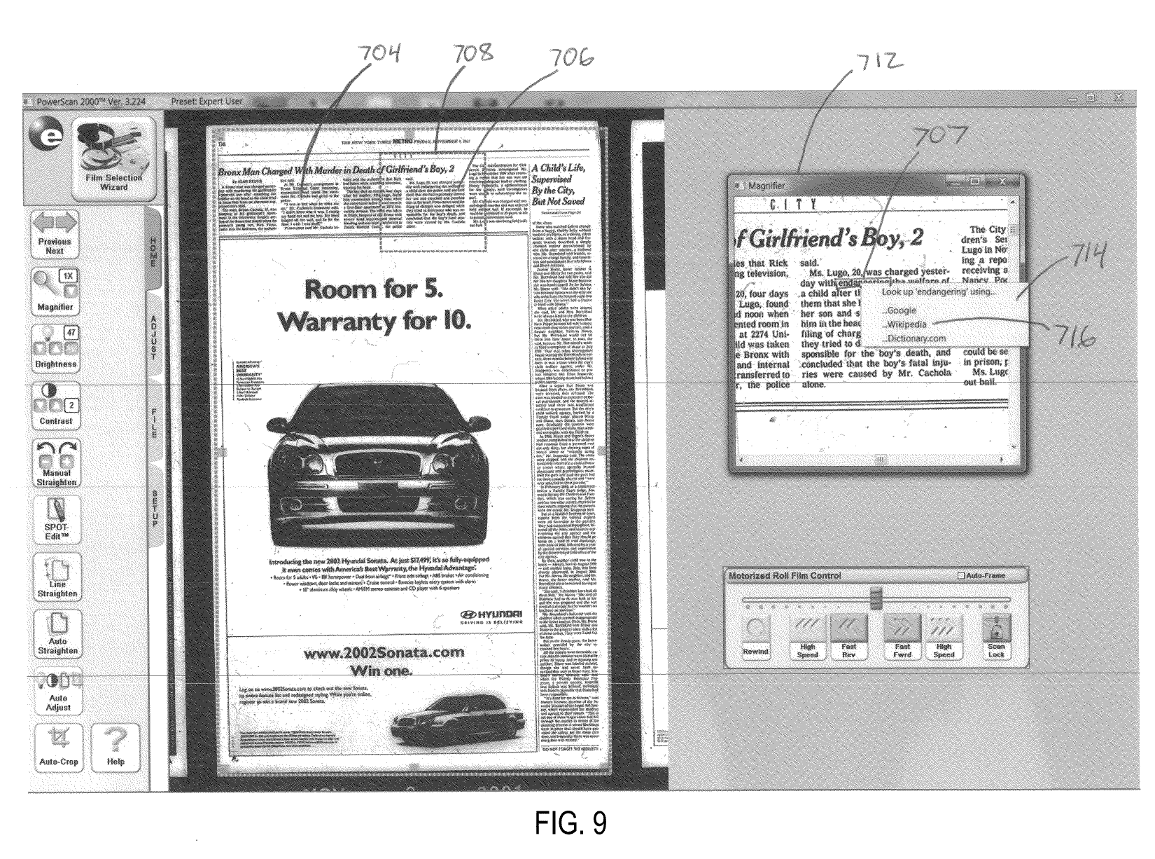

Referring to FIGS. 8 and 9, FIG. 8 illustrates one embodiment of a method as described above for passing OCR results to a separate local or remote software program. FIG. 9 illustrates an example of monitor 642 displaying an example of image data 704. In step 700, image data 704 is displayed on monitor 642. The image data 704 can display text and graphics, or just text or just graphics, as non-limiting examples. At step 710, the computer 602 then receives an indication of an area 706 on the monitor that a user has selected. An indicator box 708 identifies the region of image data 704 that can be illustrated in a magnifier window 712. By clicking on indicator box 708 and dragging it around image data 704, a user can pan around image data 704, with the image data of new regions being shown in the magnifier window 712. In step 720, the user selects (e.g., clicks using a mouse or touches using a touch screen) a region 707 (or regions) that may then be highlighted and then OCR'ed to produce OCR results that can be used by the separate software program. The user can select the region 707 anywhere in the image data 704, or optionally, from that magnifier window 712. The region 707 can include a single word or multiple words, for example.

Optionally, a software selection menu 714 provides options for separate software programs. This menu 714 may be presented when the desired region, or regions, are selected. Once the user has completed the selection of the desired region, she then clicks on the desired software program 716 for execution. At step 730, the OCR results are passed to the selected software program for use by the software program. In an alternative embodiment, the selected region 707 would be OCR'ed after the user has selected the desired software program for execution. It is to be appreciated that the method need not pass the OCR results to separate software. It is contemplated that the computer 602, or the software used to view the unrecognized text, for example, may include integral software capable of receiving the OCR results and performing some function on the OCR results. In addition, the computer 602 or the software used to view the unrecognized text may include an integral web browser such that the web browser is capable of accessing or receiving the OCR results to perform an action on the OCR results, including opening a search engine to perform a search, as a non-limiting example.

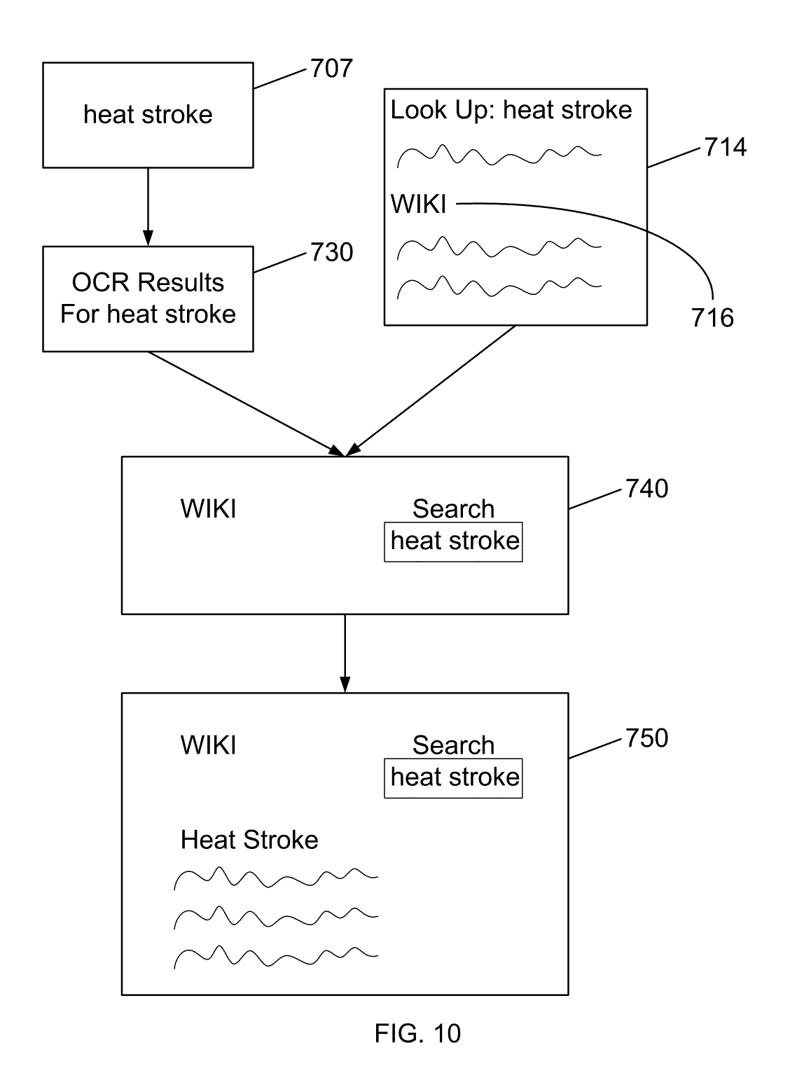

For example, as seen in FIG. 10, if the highlighted region 707 on the monitor shows “heat stroke”, and if the selected software program 716 is a web based encyclopedia such as WIKI, the default web browser on the computer would open to the appropriate WIKI website, the OCR results would be passed to the WIKI website 730, automatically being placed in the WIKI search box 740, and the search would be executed, and the results of the search would be displayed, as shown at 750.

Optionally, the user could select a new region 707 prior to selecting the separate software program in menu 714, or the user could select the desired software program 716, thereby passing the OCR results to the selected software program for execution. The user could then continue by selecting a new region 707, thereby repeating the process.

FIG. 11 illustrates a general computer environment 600, which can be used to implement the techniques according to the present invention as described above. The computer environment 600 is only one example of a computing environment and is not intended to suggest any limitation as to the scope of use or functionality of the computer and network architectures. Neither should the computer environment 600 be interpreted as having any dependency or requirement relating to any one or combination of components illustrated in the example computer environment 600.

Computer environment 600 includes a general-purpose computing device in the form of a computer 602. The components of computer 602 can include, but are not limited to, one or more processors or processing units 604, system memory 606, and system bus 608 that couples various system components including processor 604 to system memory 606.

System bus 608 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, a PCI Express bus, a Universal Serial Bus (USB), a Secure Digital (SD) bus, or an IEEE 1394, i.e., FireWire, bus.

Computer 602 may include a variety of computer readable media. Such media can be any available media that is accessible by computer 602 and includes both volatile and non-volatile media, removable and non-removable media.

System memory 606 includes computer readable media in the form of volatile memory, such as random access memory (RAM) 610; and/or non-volatile memory, such as read only memory (ROM) 612 or flash RAM. Basic input/output system (BIOS) 614, containing the basic routines that help to transfer information between elements within computer 602, such as during start-up, is stored in ROM 612 or flash RAM. RAM 610 typically contains data and/or program modules that are immediately accessible to and/or presently operated on by processing unit 604.

Computer 602 may also include other removable/non-removable, volatile/non-volatile computer storage media. By way of example, FIG. 5 illustrates hard disk drive 616 for reading from and writing to a non-removable, non-volatile magnetic media (not shown), magnetic disk drive 618 for reading from and writing to removable, non-volatile magnetic disk 620 (e.g., a “floppy disk”), and optical disk drive 622 for reading from and/or writing to a removable, non-volatile optical disk 624 such as a CD-ROM, DVD-ROM, or other optical media. Hard disk drive 616, magnetic disk drive 618, and optical disk drive 622 are each connected to system bus 608 by one or more data media interfaces 625. Alternatively, hard disk drive 616, magnetic disk drive 618, and optical disk drive 622 can be connected to the system bus 608 by one or more interfaces (not shown).

The disk drives and their associated computer-readable media provide non-volatile storage of computer readable instructions, data structures, program modules, and other data for computer 602. Although the example illustrates a hard disk 616, removable magnetic disk 620, and removable optical disk 624, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 616, magnetic disk 620, optical disk 624, ROM 612, and/or RAM 610, including by way of example, operating system 626, one or more application programs 628, other program modules 630, and program data 632. Each of such operating system 626, one or more application programs 628, other program modules 630, and program data 632 (or some combination thereof) may implement all or part of the resident components that support the distributed file system.

One example of an application program 628 is an OCR engine used as described in the method of FIG. 8. The OCR engine may be a commercially available program. One such OCR engine is named ABBYY FineReader and is available from ABBYY USA, Inc.

A user can enter commands and information into computer 602 via input devices such as keyboard 634 and a pointing device 636 (e.g., a “mouse”). Other input devices 638 (not shown specifically) may include a microphone, joystick, game pad, satellite dish, serial port, scanner, and/or the like. These and other input devices are connected to processing unit 604 via input/output interfaces 640 that are coupled to system bus 608, but may be connected by other interface and bus structures, such as a parallel port, game port, or a universal serial bus (USB).

Monitor 642 or other type of display device can also be connected to the system bus 608 via an interface, such as video adapter 644. In addition to monitor 642, other output peripheral devices can include components such as speakers (not shown) and printer 646 which can be connected to computer 602 via I/O interfaces 640. In addition, monitor 642 may comprise a touch screen so as to allow the user to provide input to the processing unit 604 by simply touching the screen.

Computer 602 can operate in a networked environment using logical connections to one or more remote computers, such as remote computing device 648. By way of example, remote computing device 648 can be a PC, portable computer, a server, a router, a network computer, a peer device or other common network node, and the like. Remote computing device 648 is illustrated as a portable computer that can include many or all of the elements and features described herein relative to computer 602. Alternatively, computer 602 can operate in a non-networked environment as well.

Logical connections between computer 602 and remote computer 648 are depicted as a local area network (LAN) 650 and a general wide area network (WAN) 652. Such networking environments are commonplace in offices, enterprise-wide computer networks, intranets, and the Internet.

When implemented in a LAN networking environment, computer 602 is connected to local network 650 via network interface or adapter 654. When implemented in a WAN networking environment, computer 602 typically includes modem 656 or other means for establishing communications over wide network 652. Modem 656, which can be internal or external to computer 602, can be connected to system bus 608 via I/O interfaces 640 or other appropriate mechanisms. It is to be appreciated that the illustrated network connections are examples and that other means of establishing at least one communication link between computers 602 and 648 can be employed.

In a networked environment, such as that illustrated with computing environment 600, program modules depicted relative to computer 602, or portions thereof, may be stored in a remote memory storage device. By way of example, remote application programs 658 reside on a memory device of remote computer 648. For purposes of illustration, applications or programs and other executable program components such as the operating system are illustrated herein as discrete blocks, although it is recognized that such programs and components reside at various times in different storage components of computing device 602, and are executed by at least one data processor of the computer.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

The present invention is not limited by the DMIA 22 shown as there are other DMIAs, or microfilm or micro opaque readers, scanners, etc., which are available which can be used in conjunction with a computer and the CUI of the present invention. Further, the present invention is not limited by a separate DMIA 22 and computer 602. For example, computer 602 can be integrated into DMIA 22, or can be part of controller 116. Yet further, monitor 642 can be a part of DMIA 22, or one of these variation, instead of a separate device.

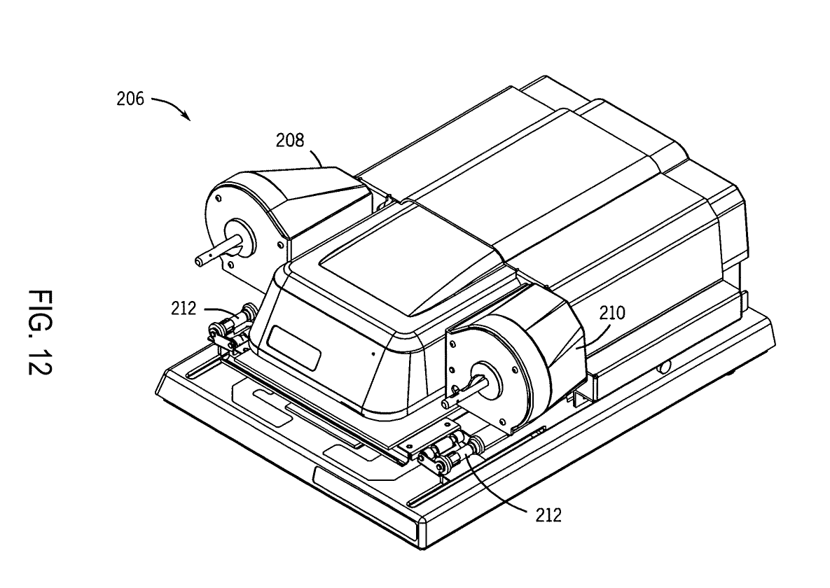

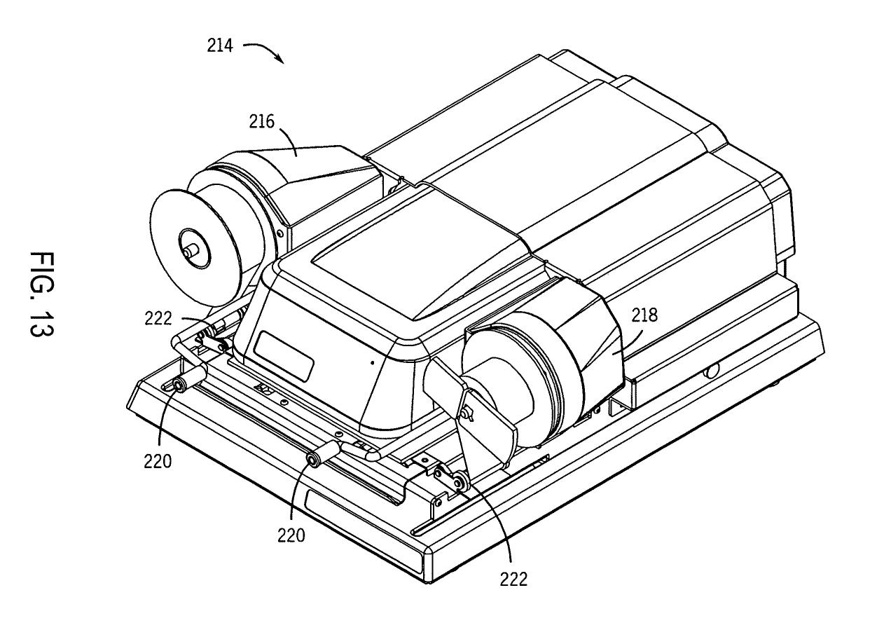

Media 46 can include any microform image formats such as microfilm/microfiche, aperture cards, jackets, 16 mm or 35 mm film roll film, cartridge film and other micro opaques. Micro opaques are different than transparent film. Images are recorded on an opaque medium. To view these micro images one needs to use reflected light. The present invention can use LED arrays 37 (FIGS. 5 and 6) for use with micro opaques, which can be the same, or similar to, the monochromatic LED's that are used in illumination source 36. In the embodiment of FIG. 12, DMIA 206 includes a microform media support in the form of motorized roll film attachment with supply side 208 and take up side 210 and film guides 212, in addition to X-Y table 44. In the embodiment of FIG. 13, DMIA 214 includes a microform media support in the form of hand operated roll film attachment with supply side 216 and take up side 218 with cranks 220, and film guides 222, in addition to X-Y table 44. In other ways, DMIAs 206 and 214 are similar to or the same as DMIA 22. Therefore, the microform media support structure according to the present invention is at least one of a X-Y table, a motorized roll film carrier, and a hand operated roll film carrier, and a cartridge film carrier.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

I claim:

1. A method for providing optical character recognition results for use to perform some action, the method comprising the steps of:
providing an image on a monitor;
receiving an indication of at least one region on the monitor for optical character recognition (OCR);
initiating OCR of the indicated at least one region for producing OCR results; and
using the OCR results to perform some action.

2. The method of claim 1, wherein using the OCR results to perform some function further includes passing the OCR results to at least one software program for use by the at least one software program.

3. The method of claim 1, wherein the image on the monitor includes a graphic image of text.

4. The method of claim 2, further including providing a software selection menu on the monitor, the software selection menu indicating the at least one software program to receive the OCR results.

5. The method of claim 1, further including selecting at least one region on the monitor and placing a box around the at least one region.

6. The method of claim 5, wherein selecting at least one region on the monitor includes highlighting the at least one region.

7. The method of claim 5, wherein selecting at least one region on the monitor includes clicking on the screen near the at least one region.

8. The method of claim 5, wherein selecting at least one region on the monitor includes using a mouse for the selecting.

9. The method of claim 5, wherein the monitor is a touch screen monitor, and wherein selecting at least one region on the monitor includes touching the screen for selecting the at least one region.

10. The method of claim 4, wherein the software selection menu indicates more than one software program to receive the OCR results.

11. The method of claim 10, further including selecting at least one of the software programs to receive the OCR results.

12. The method of claim 2, wherein the at least one software program is an Internet based program.

13. The method of claim 2, wherein the at least one software program is an Internet based search engine.

14. The method of claim 2, wherein passing the OCR results to the at least one software program includes opening a web browser, the web browser then opening the at least one software program for receipt of the OCR results.

15. The method of claim 14, further including opening the web browser, passing the OCR results to the web browser and executing a search based on the OCR results.

16. The method of claim 1, wherein the image on the monitor is an image generated from microform.

17. A computer-readable storage medium having at least one instruction to be executed by at least one processor that has been provided image data of a digital image by a digital imaging apparatus, the at least one instruction causing the at least one processor to:
provide the image data of the digital image on a display;
receive an indication of at least one region on the display for optical character recognition (OCR);
initiate an OCR of the indicated at least one region to produce OCR results; and
pass the OCR results to the at least one software program for use by the at least one software program.

18. The computer-readable storage medium of claim 17, further including indicate at least one software program to receive the OCR results.

19. A digital imaging system, comprising:
a digital microform imaging apparatus which images a segment of a microform image to produce image data; and
a computer including at least one processor and a computer-readable storage medium readable by the at least one processor, the computer-readable storage medium having at least one instruction causing the at least one processor to:
display the image data of the microform segment on a display connected to the computer using a computer user interface having a display area;
receive an indication of at least one region on the display for optical character recognition (OCR);
initiate an OCR of the indicated at least one region to produce OCR results; and
pass the OCR results to at least one software program for use by the at least one software program.
